(19) United States
(12) Patent Application Publication
(10) Pub. No.: US 2019/0185015 A1
(43) Pub. Date: Jun. 20, 2019

(54) APPARATUS FOR LIMITING VEHICLE SPEED AND METHOD THEREOF

(71) Applicants: HYUNDAI MOTOR COMPANY, Seoul (KR); KIA MOTORS CORPORATION, Seoul (KR)

(72) Inventors: Young Chul KIM, Seongnam-si (KR); Lee Hyoung CHO, Suwon-si (KR); Sang Joon KIM, Seoul (KR); Dong Ho YANG, Incheon (KR)

(21) Appl. No.: 16/050,635

(22) Filed: Jul. 31, 2018

(30) Foreign Application Priority Data
Dec. 15, 2017 (KR) 10-2017-0173570

(51) Int. Cl. B60W 40/105; B60W 30/182; B60W 30/14

(52) U.S. Cl. CPC B60W 40/105; B60W 30/182; B60K 2031/0091; F02D 2200/501; B60W 30/146

(57) ABSTRACT

The present disclosure relates to an apparatus for limiting vehicle speed and a method thereof. To prevent a vehicle from exceeding a speed limit to secure safety and improve fuel economy, the apparatus includes: a mode setting device allowing a driver to set any one of a safety mode, a fuel economy mode, and a hybrid mode; a safety speed input device allowing the driver to input a safety speed; one or more processors determining an economical speed on the basis of a driving environment of a vehicle; and a controller limiting a speed of the vehicle on the basis of the safety speed or the economical speed according to a mode set by the driver.

### CROSS-REFERENCE TO RELATED APPLICATION

This application is based on and claims the benefit of priority to Korean Patent Application No. 10-2017-0173570, filed on Dec. 15, 2017, in the Korean Intellectual Property Office, the disclosure of which is incorporated herein in its entirety by reference.

### TECHNICAL FIELD

The present disclosure relates to an apparatus for limiting vehicle speed, and a method thereof and, more particularly, to a technique for improving fuel economy of a vehicle by limiting the speed of the vehicle on the basis of an economical speed according to the driving environment of the vehicle.

### BACKGROUND

In recent years, as vehicle performance and road environment have improved, traffic accidents due to overspeeding are increasing.

In Europe, drivers are allowed to set a speed limit of a vehicle, and an incentive is given to a vehicle equipped with a speed limiter that controls the speed of the vehicle to prevent the speed from increasing even though the driver presses an accelerator pedal when exceeding the speed limit.

In a conventional technique for limiting the speed of the vehicle, since the speed of the vehicle is limited on the basis of the speed limit set by the driver, the safety of the vehicle may be secured. However, such a speed limit is set without taking the driving environment of the vehicle into consideration. Thus, it would be difficult to improve fuel economy of the vehicle.

For example, the speed limit set by the driver may be a general road speed limit (for example, 80 km/h). Even if it is appropriate to drive at a speed of 60 km/h according to the driving environment of the vehicle, it may unnecessarily accelerate to 80 km/h and then decelerate to 60 km/h, thereby deteriorating the fuel economy of the vehicle.

### SUMMARY

The present disclosure has been made to solve the above-mentioned problems occurring in the related art while advantages achieved by the related art are maintained intact.

An aspect of the present disclosure provides an apparatus of a vehicle for limiting vehicle speed and a method thereof that can prevent a vehicle from exceeding a speed limit to secure safety and improve fuel economy by calculating an economical speed corresponding to the driving environment of the vehicle and limiting the driving speed of the vehicle on the basis of the calculated economical speed.

According to an aspect of the present disclosure, an apparatus of a vehicle for limiting vehicle speed may include: a mode setting device for allowing a driver to set any one of a safety mode, a fuel economy mode, and a hybrid mode; a safety speed input device for allowing the driver to input a safety speed; one or more processors configured to determine an economical speed on the basis of a driving environment of the vehicle; and a controller communicatively connected to the one or more processors and configured to limit a speed of the vehicle on the basis of the safety speed or the economical speed according to a mode set by the driver.

The one or more processors may be further configured to determine, as a final economical speed, a minimum speed among an economical speed on the basis of a speed of a subject vehicle and a speed of a preceding vehicle, an economical speed on the basis of a fuel economy graph according to the speed of the subject vehicle, an economical speed on the basis of a speed profile according to a distance between the subject vehicle and a front obstacle, and a maximum speed of a driving road.

The controller may limit the speed of the vehicle on the basis of a torque corresponding to the input safety speed in the safety mode.

The controller may limit the speed of the vehicle on the basis of a torque corresponding to the determined economical speed in the fuel economy mode.

The controller may limit the speed of the vehicle on the basis of a torque corresponding to a lower speed of the input safety speed and the determined economical speed in the hybrid mode.

The one or more processors may be further configured to calculate a required torque of the driver on the basis of a voltage value transmitted from an accelerator position sensor (APS).

The controller may limit the speed of the vehicle on the basis of a lower torque of a torque corresponding to the input safety speed and the required torque of the driver in the safety mode.

The controller may limit the speed of the vehicle on the basis of a lower torque of a torque corresponding to the determined economical speed and the required torque of the driver in the fuel economy mode.

The controller may limit the speed of the vehicle on the basis of a lower torque of a torque corresponding to the input safety speed, a torque corresponding to the determined economical speed, and the required torque of the driver in the hybrid mode.

According to another aspect of the present disclosure, a method for limiting a speed of a vehicle may include: receiving, by a mode setting device, any one of a safety mode, a fuel economy mode, and a hybrid mode which is set by a driver; receiving, by a safety speed input device, a safety speed which is input by the driver in the safety mode or the hybrid mode; determining, by one or more processor, an economical speed on the basis of a driving environment of a vehicle in the fuel economy mode; and limiting, by a controller, a speed of the vehicle on the basis of the safety speed or the economical speed according to a mode set by the driver.

The determining of the economical speed may include: calculating a first economical speed on the basis of a speed of a subject vehicle and a speed of a preceding vehicle; calculating a second economical speed on the basis of a fuel economy graph according to the speed of the subject vehicle; calculating a third economical speed on the basis of a speed profile according to a distance between the subject vehicle and a front obstacle; acquiring a maximum speed of a driving road; and determining, as a final economical speed, a minimum speed among the first to third economical speeds and the maximum speed.

The limiting of the speed may include limiting the speed of the vehicle on the basis of a torque corresponding to the input safety speed in the safety mode.

The limiting of the speed may include limiting the speed of the vehicle on the basis of a torque corresponding to the determined economical speed in the fuel economy mode.

The limiting of the speed may include limiting the speed of the vehicle on the basis of a torque corresponding to a lower speed of the input safety speed and the determined economical speed in the hybrid mode.

The method may further include calculating a required torque of the driver on the basis of a voltage value transmitted from an accelerator position sensor (APS).

The limiting of the speed may include limiting the speed of the vehicle on the basis of a lower torque of a torque corresponding to the input safety speed and the required torque of the driver in the safety mode.

The limiting of the speed may include limiting the speed of the vehicle on the basis of a lower torque of a torque corresponding to the determined economical speed and the required torque of the driver in the fuel economy mode.

The limiting of the speed may include limiting the speed of the vehicle on the basis of a lower torque of a torque corresponding to the input safety speed, a torque corresponding to the determined economical speed, and the required torque of the driver in the hybrid mode.

According to another aspect of the present disclosure, an apparatus of a vehicle for limiting vehicle speed may include: an economical speed determination processor configured to determine an economical speed on the basis of a driving environment of a vehicle; a torque calculation processor configured to calculate a required torque of a driver; and a controller communicatively connected to the economical speed determination processor and the torque calculation processor, and configured to limit a speed of the vehicle on the basis of a lower torque of a torque corresponding to the determined economical speed and the required torque of the driver.

According to another aspect of the present disclosure, a method for limiting a speed of a vehicle may include: determining, by an economical speed determination processor, an economical speed on the basis of a driving environment of a vehicle; calculating, by a torque calculation processor, a required torque of a driver; and limiting, by a controller, a speed of the vehicle on the basis of a lower torque of a torque corresponding to the determined economical speed and the required torque of the driver.

### BRIEF DESCRIPTION OF THE DRAWINGS

The above and other objects, features and advantages of the present disclosure will be more apparent from the following detailed description taken in conjunction with the accompanying drawings:

FIG. 1 schematically illustrates the appearance of a vehicle to which the present inventive concept is applied;

FIG. 2 illustrates the internal structure of a vehicle to which the present inventive concept is applied;

FIG. 3 illustrates the configuration of an apparatus for limiting vehicle speed, according to an exemplary embodiment of the present disclosure;

FIG. 4 illustrates the configuration of an economical speed determination module in an apparatus for limiting vehicle speed, according to an exemplary embodiment of the present disclosure;

FIG. 5 illustrates a flowchart of a method for limiting a speed of a vehicle, according to an exemplary embodiment of the present disclosure;

FIG. 6 illustrates the configuration of an apparatus for limiting vehicle speed, according to another exemplary embodiment of the present disclosure;

FIG. 7 illustrates a flowchart of a method for limiting a speed of a vehicle, according to another exemplary embodiment of the present disclosure;

FIG. 8 illustrates a graph of fuel economy according to a speed of a subject vehicle, according to an exemplary embodiment of the present disclosure;

FIG. 9 illustrates an economical speed profile according to a distance to a preceding vehicle, according to an exemplary embodiment of the present disclosure; and

FIG. 10 illustrates a block diagram of a computing system by which a method for limiting a speed of a vehicle according to an exemplary embodiment of the present disclosure is executed.

### DETAILED DESCRIPTION

Hereinafter, exemplary embodiments of the present disclosure will be described in detail with reference to the accompanying drawings. In the drawings, the same reference numerals will be used throughout to designate the same or equivalent elements. In addition, a detailed description of well-known techniques associated with the present disclosure will be ruled out in order not to unnecessarily obscure the gist of the present disclosure.

Terms such as first, second, A, B, (a), and (b) may be used to describe the elements in exemplary embodiments of the present disclosure. These terms are only used to distinguish one element from another element, and the intrinsic features, sequence or order, and the like of the corresponding elements are not limited by the terms. Unless otherwise defined, all terms used herein, including technical or scientific terms, have the same meanings as those generally understood by those with ordinary knowledge in the field of art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

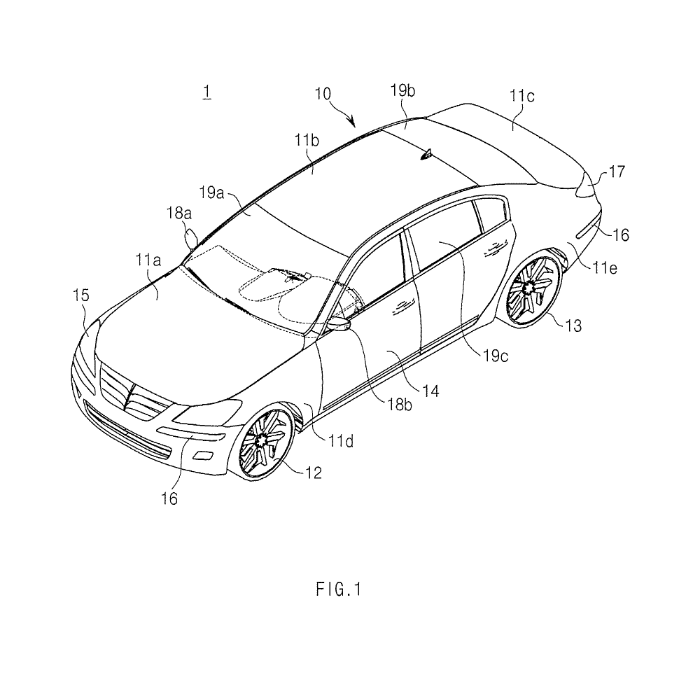

FIG. 1 schematically illustrates the appearance of a vehicle to which the present inventive concept is applied.

Referring to FIG. 1, a vehicle 1 includes a vehicle body 10 forming the appearance thereof, and wheels 12 and 13 moving the vehicle 1.

The vehicle body 10 includes a hood 11a protecting a variety of devices, such as an engine, a motor, a battery, and a transmission, required to drive the vehicle 1, a roof panel 11b for the formation of an interior space, a trunk lid 11c providing a storage space, and front fenders 11d and quarter panels 11e provided on the sides of the vehicle 1. In addition, a plurality of doors 15 may be provided on the sides of the vehicle body 10 to be hinge-coupled to the vehicle body 10.

A front window (windshield) 19a may be disposed between the hood 11a and the roof panel 11b to provide visibility in front of the vehicle 1, and a rear window 19b may be disposed between the roof panel 11b and the trunk lid 11c to provide visibility behind the vehicle 1. In addition, side windows 19c may be disposed in upper portions of the doors 15 to provide visibility to the side.

In addition, headlamps 15 may be placed on the front of the vehicle 1 for illuminating in a travelling direction of the vehicle 1.

In addition, turn signal lamps 16 may be placed on the front and rear of the vehicle 1 for signaling a change of the direction of the vehicle 1.

The vehicle 1 may indicate the traveling/turning direction thereof by allowing the turn signal lamp 16 to flicker. In addition, tail lamps 17 may be placed on the rear of the vehicle 1. The tail lamps 17 may display a gear shift state, a brake operating state, and the like of the vehicle 1.

The exterior of the vehicle body may include side-view mirrors 18a and 18b providing the driver's rearward visibility behind the vehicle 1.

The vehicle 1 may be an electric vehicle. Here, the electric vehicle includes an engine, a motor, a battery, and a transmission, and a controller thereof may control the conditions of the engine, the motor, the battery, and the transmission by performing controller area network (CAN) communications with a battery controller (not shown) to deliver power to the vehicle.

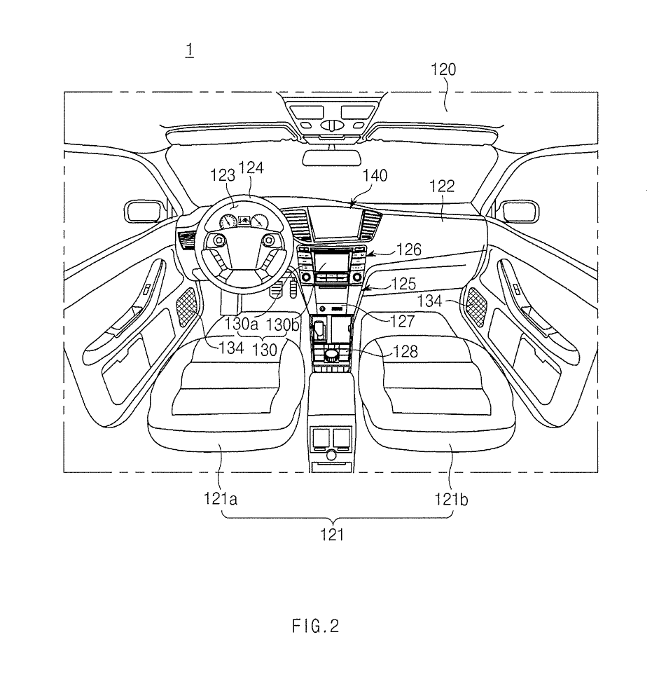

FIG. 2 illustrates the internal structure of a vehicle to which the present inventive concept is applied.

As illustrated in FIG. 2, the interior 120 of a vehicle includes seats 121 in which occupants sit, a dashboard 122, an instrument panel (cluster) 123 disposed on the dashboard and including a tachometer, a speedometer, a coolant temperature indicator, a turn signal indicator, high beam indicator light, warning lights, seat-belt warning light, a trip odometer, an odometer, a gearshift position indicator, door open warning light, oil warning light, and low fuel warning light, a steering wheel 124 controlling the direction of the vehicle 1, and a center fascia 125 including vents of an air conditioner, a control pad, and an audio system.

The seats 121 include a driver seat 121a in which a driver sits, a front passenger seat 121b in which a passenger sits, and rear seats located in the rear of the interior of the vehicle 1.

The cluster 123 may be implemented in a digital manner. In other words, the cluster (digital instrument panel) 123 may display images related to vehicle state information and vehicle driving information, and display a driving range (travelable distance) of the vehicle 1 which is calculated on the basis of the charge amount (state of charge) of the battery.

The center fascia 125 may be located on the dashboard 122 between the driver seat 121a and the passenger seat 121b.

The center fascia 125 may be provided with a head unit 126 for controlling the air conditioner and a heater.

The head unit 126 may include a variety of buttons for controlling the air conditioner and the heater.

A controller for controlling the air conditioner and the heater may be disposed inside the head unit 126.

The head unit 126 may include an audio system 130 which performs a radio function, an input unit 130a which receives the input of an operation command of the audio system 130, and a display unit 130b which displays operation information. Here, the audio system 130 provided in the vehicle 1 may be a head unit having a radio function, or an audio video navigation (AVN) terminal for a vehicle having a radio function.

The audio system 130 may receive a broadcast signal to output a broadcast. For example, as illustrated in FIG. 2, the audio system 130 may be disposed in the center fascia 125, and speakers 134 receiving the broadcast signal from the audio system 130 to output the broadcast may be installed on the front doors of the vehicle. However, FIG. 2 merely shows an example of the installation position of the speaker 134, and the speaker may be installed in any place of the interior of the vehicle.

Here, the display unit 130b may also display the operation information of the air conditioner and the heater. In addition, an interface in relation to the operation of the vehicle may be displayed on the display unit 130b, and an interface with respect to the travelable distance of the vehicle 1 may also be displayed on the display unit 130b.

The center fascia 125 may be provided with vents, a cigar jack, and the like. In addition, the center fascia 125 may be provided with multiple terminals 127 to which external devices including a user terminal (not shown) are wired connected. In other words, the multiple terminals 127 may enable wired communications between the head unit 126 or a vehicle terminal 140 and the user terminal (not shown).

Here, the multiple terminals 127 may include a USB port and an AUX terminal, and further include a SD slot, and may be disposed adjacent to the head unit 126. In addition, the multiple terminals 127 may be disposed adjacent to the vehicle terminal 140, and may be electrically connected to the vehicle terminal 140 and the external devices through a connector or a cable.

Examples of the external devices may include a storage device, a user terminal, an MP3 player, and the like. The storage device may include a card-type memory and an external hard disk.

In addition, the user terminal included in the external device may be a mobile communication terminal, and examples thereof may include a smartphone, a notebook, a tablet, and the like. The vehicle 1 may further include an operation unit 128 receiving the input of operation commands for various functions.

The operation unit 128 may be provided on the head unit 126 and the center fascia 125, and may include at least one physical button such as an operation on/off button for various functions, and a button for changing setting values of various functions. The operation unit 128 may transmit an operation signal of the button to the controller in the head unit 126 or the vehicle terminal 140. In other words, the operation unit 128 may receive the input of an operation on/off command of the vehicle terminal 140, allow the user to select at least one of the plurality of functions, and transmit the selected function to the vehicle terminal 140.

For example, when a navigation function is selected, the operation unit 128 may receive destination information, and transmit the received destination information to the vehicle terminal 140. When a DMB function is selected, the operation unit 128 may receive broadcast channel and volume information, and transmit the received information to the vehicle terminal 140. When a radio function is selected, the operation unit 128 may receive radio channel and volume information, and transmit the received information to the vehicle terminal 140 or the display unit 130b.

The operation unit 128 may include a touch panel integrated with the display unit of the vehicle terminal. The operation unit 128 may be displayed and activated in the form of a button on the display unit of the vehicle terminal 140, and receive location information of the displayed button.

The operation unit 128 may further include a jog dial (not shown) or a touch pad for the input of a movement command, a selection command, and the like of a cursor displayed on the display unit of the vehicle terminal 140. The operation unit 128 may transmit an operation signal of the jog dial or a touch signal activated on the touch pad to the vehicle terminal 140.

Here, the jog dial or the touch pad may be provided on the center fascia. The operation unit 128 may also receive the input of an automatic channel switching command when the radio function is performed.

In addition, the user may input a control command that changes an operation mode of the vehicle 1 through the operation unit 128, and may also input a control command with respect to each element of the vehicle 1.

The display unit 130b may display the operation information of the head unit 126, and display information that is input to the operation unit 128.

For example, when the radio function is selected, the display unit 130b may display the radio channel and volume information input by the user.

When the radio function is performed, the display unit 130b may display information on the input of the automatic channel switching command and the execution of the automatic channel switching command.

The vehicle terminal 140 may be installed in a holder on the dashboard.

The vehicle terminal 140 may perform audio, video, navigation, DMB, radio, and GPS functions.

A chassis of the vehicle 1 includes a power generation system, a power transmission system, a running gear, a steering system, a braking system, a suspension system, a transmission system, a fuel supply system, wheels (front, rear, left, and right wheels), and the like.

In addition, the vehicle 1 may include a variety of safety devices for the safety of the driver and the occupants.

For example, the vehicle 1 may include various kinds of safety devices such as an airbag control device for the safety of the driver and the occupant(s) in the event of a vehicle collision, and an electronic stability control (ESC) device controlling the posture of the vehicle while accelerating or cornering.

In addition, the vehicle 1 may further include a variety of sensors such as a proximity sensor detecting obstacles and other vehicles to the rear or side of the vehicle, a rain sensor detecting whether it rains or not and measuring rainfall, a wheel speed sensor detecting the speed of the front, rear, left, and right wheels, an acceleration sensor detecting acceleration of the vehicle, an angular velocity sensor detecting an angular velocity of the vehicle.

The vehicle 1 may include an electronic control unit (ECU) controlling the operations of the power generation system, the power transmission system, the running gear, the steering system, the braking system, the suspension system, the transmission system, the fuel supply system, a battery management system, and various kinds of safety devices and sensors.

In addition, the vehicle 1 may further include electronic devices, such as a hands-free device, a Bluetooth device, a rear camera, a charging device for a user terminal, and a hi-pass system, for the convenience of the driver.

The vehicle 1 may further include a start button for inputting an operation command to a starter motor (not shown). In other words, when the start button is turned on, the vehicle 1 may operate the starter motor, and drive the power generation system, that is, an engine (not shown) through the operation of the starter motor.

The vehicle 1 may include a battery (not shown) electrically connected to the terminal, the audio system, indoor lights, the starter motor, and the other electronic devices to supply driving power.

The vehicle 1 may be an electric vehicle in which a battery for driving the vehicle is used. Here, the electric vehicle may be driven by charging the battery with electricity and driving a motor using the charged electricity. The electric vehicle battery may be charged using power from its own generator or the engine while the vehicle is driving, or may be charged in an electric charging station.

In addition, the vehicle 1 may further include a communication device for communications between various in-vehicle electronic devices and for communications with the external user terminal. The communication device may include a CAN communication module, a Wi-Fi communication module, a USB communication module, and a Bluetooth communication module. In addition, the communication device may further include a broadcasting communication module such as DMB TPEG, SXM, and RDS.

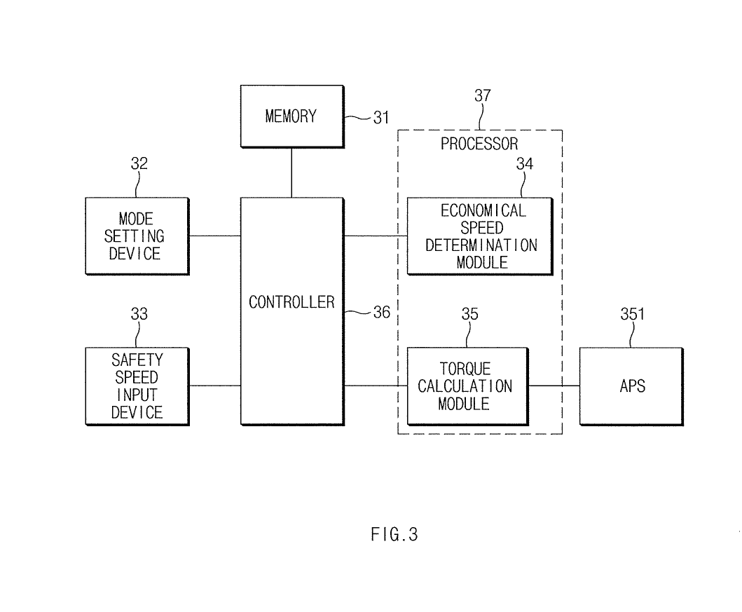

FIG. 3 illustrates the configuration of an apparatus for limiting vehicle speed according to an exemplary embodiment of the present disclosure.

As illustrated in FIG. 3, the apparatus for limiting vehicle speed according to the exemplary embodiment of the present disclosure, may include a memory 31, a mode setting device 32, a safety speed input device 33, one or more processors 37, and a controller 36. The elements may be combined into a single unit according to methods for carrying out the invention, and some of the elements may be omitted according to methods for carrying out the invention.

The one or more processors 37 may have an associated non-transitory memory storing software instructions which, when executed by the one or more processors 37, provide the functionalities of an economical speed determination module 34 and a torque calculation module 35.

With respect to each of the aforementioned elements, the memory 31 may store programs corresponding to a variety of processes performed by the controller 36, and store various types of data generated when the controller 36 performs the processes.

The memory 31 may include at least one non-transitory storage medium selected from among a flash memory, a hard disk, a solid status disk (SSD), a silicon disk drive (SDD), a multimedia card micro type memory, a card type memory (e.g., SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk.

The mode setting device 32 may be a module providing a user interface (e.g., a touch screen, etc.) or an input device such as a mouse, a joystick, a jog shuttle, a stylus pen, etc., provided with a display, and allow a user to set any one of a safety mode, a fuel economy mode, and a hybrid mode.

Here, the safety mode refers to a mode in which the speed of the vehicle is controlled on the basis of a safety speed set by a driver, the fuel economy mode refers to a mode in which the speed of the vehicle is controlled on the basis of an economical speed determined by the economical speed determination module 34, and the hybrid mode in which the safety mode and the fuel economy mode are applied in combination, and the speed of the vehicle is controlled on the basis of a lower speed of the safety speed set by the driver and the economical speed determined by the economical speed determination module 34.

The safety speed input device 33 may be a module which is activated when the driver selects the safety mode or the hybrid mode, and include a single button or a plurality of buttons to allow the driver to input a safety speed.

The economical speed determination module 34 of the one or more processors 37 may determine an economical speed corresponding to the driving environment of the vehicle. Here, the economical speed determination module 34 may be interlocked with a variety of sensors (a camera, a radar sensor, an infrared sensor, and the like), a driving assistance system, a navigation system mounted in the vehicle to acquire various information. For example, the economical speed determination module 34 may acquire road information (speed cameras, curves, speed bumps, intersections, tollgates, school zones, and the like), and information on front obstacles (preceding vehicles, pedestrians, objects, and the like). Here, the information that affects the speed of the vehicle (speed cameras, curves, speed bumps, intersections, tollgates, school zones, and the like) may also be regarded as front obstacles.

The economical speed determination module 34 may calculate the economical speed using the road information. Here, the economical speed refers to the speed of the vehicle required for environmentally friendly and economical driving. Such an economical speed may be set individually for each road information. In other words, the economical speed may be determined in a variety of settings according to the road information such as curves, ramps, school zones, speed bumps and the like.

In particular, the economical speed determination module 34 may calculate the economical speed using the road information. In addition, the economical speed determination module 34 may determine the economical speed in a variety of settings by applying a current speed of the vehicle and various models required to calculate the economical speed of the vehicle, such as a motion model, a fuel economy model, and a heat load model. In other words, the economical speed determination module 34 may calculate a variety of economical speeds that allow the vehicle to extend coasting (non-power driving) to reduce energy required to drive the vehicle for each road type by applying the road information and various models, and allow the vehicle to reach a corresponding appropriate speed with minimum energy by considering a distance from the current location of the vehicle to a road type ahead, travel time, the current speed of the vehicle, and the like.

For example, when a curve is detected in front of the vehicle as a result of analyzing the road information, the economical speed determination module 34 may calculate a driving speed corresponding to the curve, and calculate an economical speed to allow the vehicle to enter the curve at the corresponding driving speed.

In addition, when a school zone is detected in front of the vehicle as a result of analyzing the road information, the economical speed determination module 34 may detect a driving speed corresponding to the school zone, and calculate an economical speed to allow the vehicle to pass the school zone at the corresponding driving speed.

In addition, when a speed bump is detected in front of the vehicle as a result of analyzing the road information, the economical speed determination module 34 may detect a driving speed corresponding to the speed bump, and calculate an economical speed to allow the vehicle to pass the speed bump at the corresponding driving speed.

In addition, when the vehicle is driving on a ramp as a result of analyzing the road information, the economical speed determination module 34 may calculate a driving speed corresponding to the ramp, and calculate an economical speed to allow the vehicle to maintain the corresponding driving speed on the ramp.

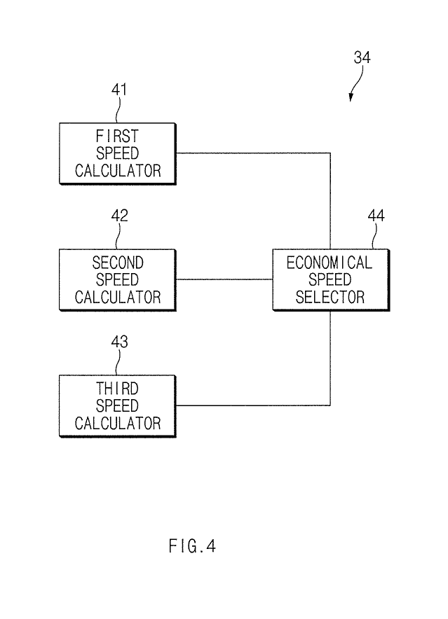

Hereinafter, details of the configuration of the economical speed determination module 34 will be described with reference to FIG. 4.

FIG. 4 illustrates the configuration of an economical speed determination module in an apparatus for limiting vehicle speed according to an exemplary embodiment of the present disclosure.

As illustrated in FIG. 4, the economical speed determination module 34 according to the exemplary embodiment of the present disclosure may include a first speed calculator 41, a second speed calculator 42, a third speed calculator 43, and an economical speed selector 44.

The first speed calculator 41 may calculate an economical speed of a subject vehicle on the basis of a speed of a preceding vehicle and a speed of the subject vehicle acquired by the radar sensor. For example, an economical speed Va may be calculated on the basis of the following equation 1:

Va=(A×V₁)+{(1−A)×V₂)} Equation 1

Here, V₁ represents a cumulative average speed of the preceding vehicle, V₂ represents a cumulative average speed of the subject vehicle, and A represents a weighted constant value.

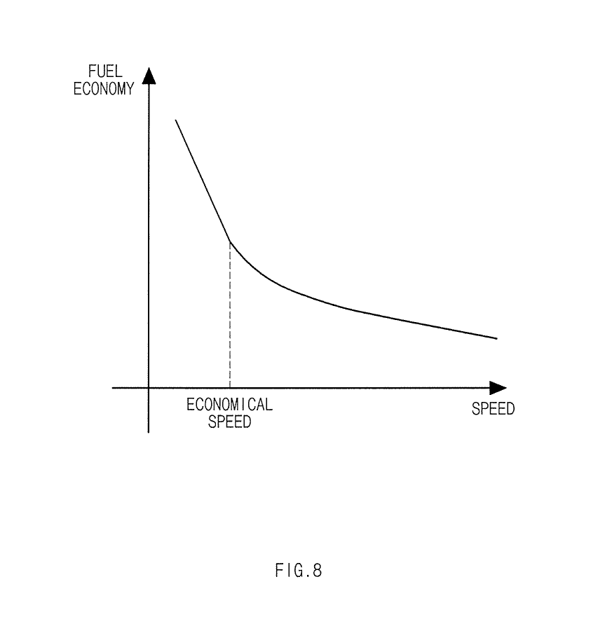

The second speed calculator 42 may calculate an economical speed on the basis of a slope of fuel economy according to the speed of the subject vehicle, as illustrated in FIG. 8. Here, the economical speed may be an inflection point of the slope, wherein the inflection point refers to a point where the slope suddenly changes (becomes gentle).

In addition, the second speed calculator 42 may calculate an economical speed on the basis of table 1 below. Here, the economical speed may be a maximum speed.

TABLE 1

| | | Maximum | Minimum |
|---|---|---|---|
| Road | | Speed | Speed |
| Classification 1 | Classification 2 | (km/h) | (km/h) |
| General Road | Two-lane | 60 | |
| | Four-lane | 80 | |
| Motorway | | 90 | 30 |
| Expressway | Two-lane | 80 | 50 |
| | Four-lane or more | 100-120 | 50 |
| School Zone | | 30 | |
| Pedestrian | | 60 | |
| Congested Area | | | |

In addition, the second speed calculator 42 may calculate a lower speed of the speed at the inflection point and the maximum speed of a corresponding road as an economical speed.

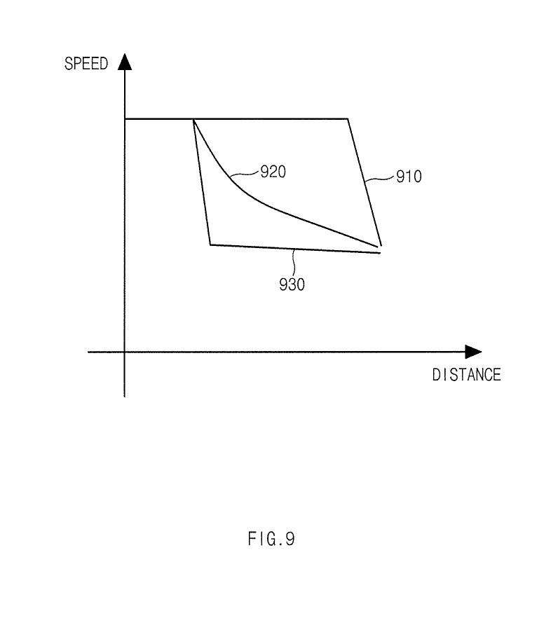

The third speed calculator 43 may calculate an economical speed on the basis of an economical speed profile according to a distance to a front obstacle, as illustrated in FIG. 9. In FIG. 9, “910” represents a speed profile during operation of a brake pedal, “920” represents a speed profile during coasting, and “930” represents an economical speed profile according to a distance to a front obstacle.

The economical speed selector 44 may select a minimum speed of a first speed calculated by the first speed calculator 41, a second speed calculated by the second speed calculator 42, and a third speed calculated by the third speed calculator 43 as an economical speed.

In addition, the economical speed determination module 34 may include its own memory to store the graph of the slope of the fuel economy according to the speed of the subject vehicle, the economical speed profile according to the distance to the front obstacle, and the like. Alternatively, the graph of the slope of the fuel economy according to the speed of the subject vehicle, and the economical speed profile according to the distance to the front obstacle may also be stored in the memory 31.

The torque calculation module 35 of the one or more processors 37 may be interlocked with an accelerator position sensor (APS) 351 to calculate a required torque of the driver. In other words, the torque calculation module 35 may calculate the degree (0-100%) of opening of an accelerator pedal on the basis of a voltage value transmitted from the APS 351, and calculate the driver's required torque of corresponding to the calculated degree of opening of the accelerator pedal. Here, the APS 351 may output a voltage value corresponding to the degree of opening of the accelerator pedal controlled by the driver.

The controller 36 generally controls the aforementioned respective elements to perform the functions thereof normally. The controller 36 may be in the form of hardware or software, or a combination of hardware and software. The controller 36 may preferably be a microprocessor, but is not limited thereto.

In addition, the controller 36 may perform a variety of processes on the basis of the programs stored in the memory.

In addition, the controller 36 may receive a specific mode which is set by the driver through the mode setting device 32, and activate a module corresponding to the specific mode.

In other words, when receiving a safety mode set by the driver through the mode setting device 32, the controller 36 may activate the safety speed input device 33 to allow the driver to directly input a safety speed. Here, the controller 36 may set the safety speed to a speed limit of the vehicle.

In addition, when receiving a fuel economy mode set by the driver through the mode setting device 32, the controller 36 may activate the economical speed determination module 34 to allow the economical speed determination module 34 to calculate an economical speed. Here, the controller 36 may set the economical speed to a speed limit of the vehicle.

In addition, when receiving a hybrid mode set by the driver through the mode setting device 32, the controller 36 may activate the safety speed input device 33 to allow the driver to directly input a safety speed, activate the economical speed determination module 34 to allow the economical speed determination module 34 to calculate an economical speed, and set a lower speed of the safety speed and the economical speed to a speed limit of the vehicle.

When the speed limit of the vehicle is set according to any one of the aforementioned methods, the controller 36 may calculate a torque corresponding to the set speed limit and limit the speed of the vehicle on the basis of the calculated torque, thereby improving the fuel economy of the vehicle.

When the speed limit of the vehicle is set according to any one of the aforementioned methods, the controller 36 may calculate a torque corresponding to the set speed limit, and compare the calculated torque with the required torque calculated by the torque calculation module 35 to determine a lower torque as a final torque of the vehicle. The controller 36 may limit the speed of the vehicle on the basis of the final torque, thereby improving the fuel economy of the vehicle.

The calculation of a torque corresponding to a speed in exemplary embodiments of the present disclosure may be performed by a variety of generally known methods, and is not limited by any one method.

When the present inventive concept is applied to a hybrid vehicle, the functions of the controller 36 may be performed by a hybrid controller (HCU).

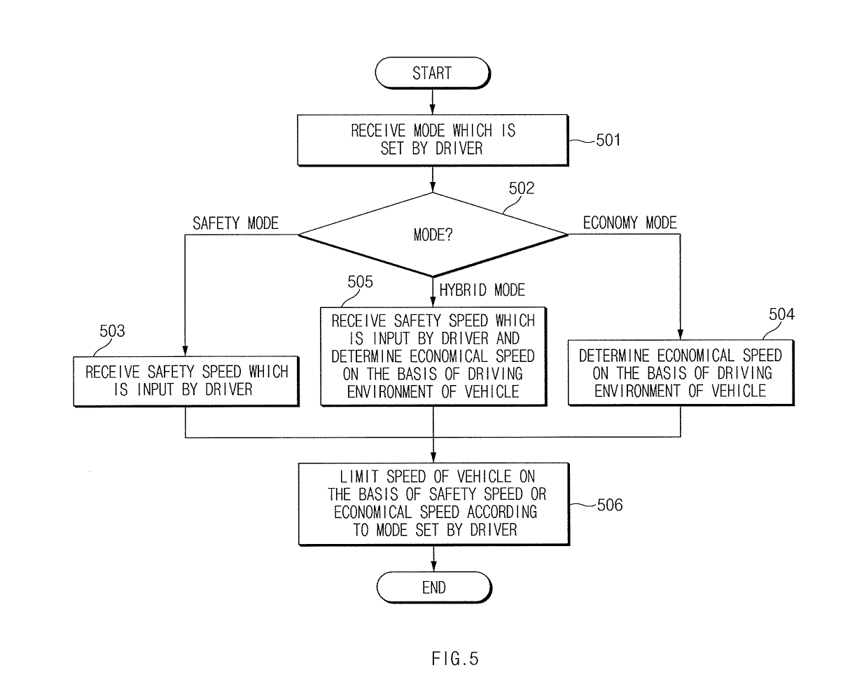

FIG. 5 illustrates a flowchart of a method for limiting a speed of a vehicle according to an exemplary embodiment of the present disclosure.

First of all, the mode setting device 32 may receive an operation mode which is set by a driver in operation 501.

Next, it may be determined whether the operation mode is a safety mode, an economy mode, or a hybrid mode in operation 502.

As a result of determination in operation 502, when the operation mode is a safety mode, the controller 36 may activate the safety speed input device 33 to receive a safety speed which is input by the driver in operation 503.

As a result of determination in operation 502, when the operation mode is an economy mode, the controller 36 may activate the economical speed determination module 34, and the economical speed determination module 34 may determine an economical speed on the basis of the driving environment of the vehicle in operation 504.

As a result of determination in operation 502, when the operation mode is a hybrid mode, the controller 36 may activate the safety speed input device 33 and the economical speed determination module 34 in operation 505. Thus, the safety speed input device 33 may receive a safety speed which is input by the driver, and the economical speed determination module 34 may determine an economical speed on the basis of the driving environment of the vehicle.

Then, the controller 36 may limit the speed of the vehicle on the basis of the safety speed or the economical speed according to a mode set by the driver in operation 506.

In other words, the controller 36 limit the speed of the vehicle on the basis of the safety speed in the safety mode, limit the speed of the vehicle on the basis of the economical speed in the economy mode, and limit the speed of the vehicle on the basis of a lower speed of the safety speed and the economical speed in the hybrid mode.

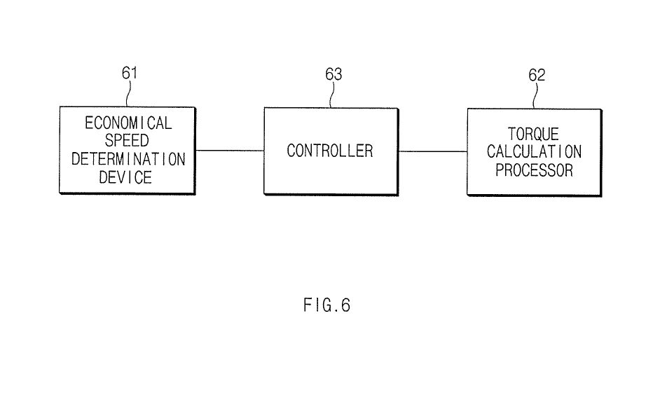

FIG. 6 illustrates the configuration of an apparatus for limiting vehicle speed according to another exemplary embodiment of the present disclosure.

As illustrated in FIG. 6, the apparatus for limiting vehicle speed according to the exemplary embodiment of the present disclosure may include an economical speed determination processor 61, a torque calculation processor 62, and a controller 63. Here, since the functions of the economical speed determination processor 61 and the torque calculation processor 62 are the same as those of the economical speed determination module 34 and the torque calculation module 35 illustrated in FIG. 3, a detailed description thereof will be omitted.

The controller 63 generally controls the aforementioned respective elements to perform the functions thereof normally. The controller 63 may be in the form of hardware or software, or a combination of hardware and software. The controller 63 may preferably be a microprocessor, but is not limited thereto.

In addition, the controller 63 may calculate a torque corresponding to an economical speed determined by the economical speed determination processor 61, and limit the speed of the vehicle on the basis of the calculated torque, thereby improving the fuel economy of the vehicle.

In addition, the controller 63 may calculate a torque corresponding to an economical speed determined by the economical speed determination processor 61, and compare the calculated torque with a required torque calculated by the torque calculation processor 62 to determine a lower torque as a final torque of the vehicle. The controller 63 may limit the speed of the vehicle on the basis of the final torque, thereby improving the fuel economy of the vehicle.

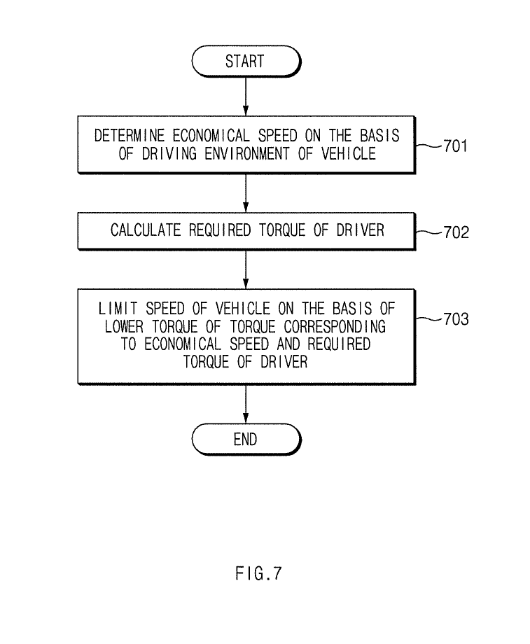

FIG. 7 illustrates a flowchart of a method for limiting a speed of a vehicle according to another exemplary embodiment of the present disclosure.

First of all, the economical speed determination processor 61 may determine an economical speed on the basis of the driving environment of the vehicle in operation 701.

Next, the torque calculation processor 62 may calculate a required torque of the driver in operation 702.

Thereafter, the controller 63 may limit the speed of the vehicle on the basis of a lower torque of a torque corresponding to the economical speed determined by the economical speed determination processor 61 and the driver's required speed calculated by the torque calculation processor 62 in operation 703.

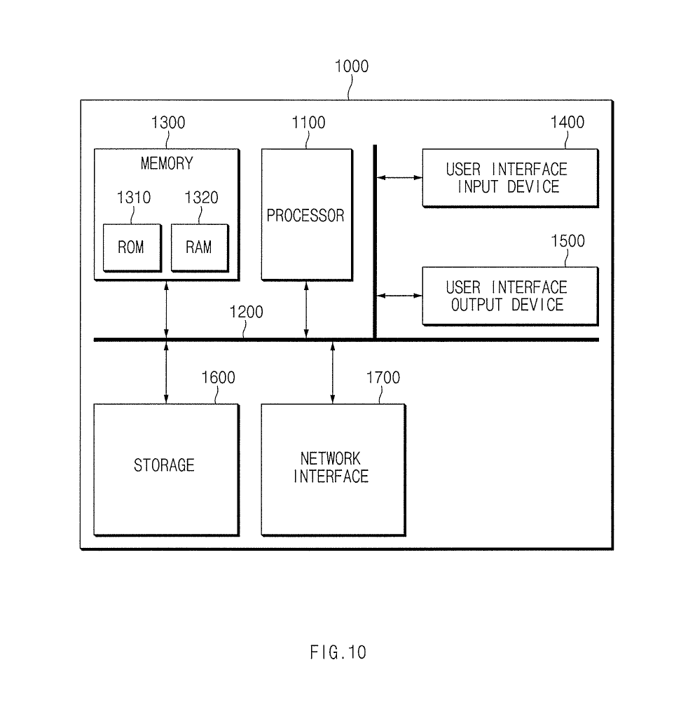

FIG. 10 illustrates a block diagram of a computing system by which a method for limiting a speed of a vehicle according to an exemplary embodiment of the present disclosure is executed.

Referring to FIG. 10, a computing system 1000 may include at least one processor 1100, a bus 1200, a memory 1300, a user interface input device 1400, a user interface output device 1500, a storage 1600, and a network interface 1700, wherein these elements are connected through the bus 1200.

The processor 1100 may be a central processing unit (CPU) or a semiconductor device processing commands stored in the memory 1300 and/or the storage 1600. The memory 1300 and the storage 1600 include various types of volatile or non-volatile storage media. For example, the memory 1300 may include a read only memory (ROM) and a random access memory (RAM).

Therefore, the steps of the method or algorithm described in connection with the exemplary embodiments disclosed herein may be embodied directly in hardware, in a software module executed by the processor 1100, or in a combination thereof. The software module may reside in a storage medium (i.e., the memory 1300 and/or the storage 1600), such as RAM, a flash memory, ROM, an erasable programmable read-only memory (EPROM), an electrically erasable programmable read-only memory (EEPROM), a register, a hard disk, a removable disk, and a CD-ROM. An exemplary storage medium may be coupled to the processor 1100, such that the processor 1100 may read information from the storage medium and write information to the storage medium. Alternatively, the storage medium may be integrated with the processor 1100. The processor 1100 and the storage medium may reside in an application specific integrated circuit (ASIC). The ASIC may reside in a user terminal. Alternatively, the processor 1100 and the storage medium may reside as discrete components in a user terminal.

As set forth above, the apparatus for limiting vehicle speed and the method thereof, according to exemplary embodiments of the present disclosure, can prevent the vehicle from exceeding a speed limit to secure safety and improve fuel economy by calculating an economical speed corresponding to the driving environment of the vehicle and limiting the driving speed of the vehicle on the basis of the calculated economical speed.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus of a vehicle for limiting vehicle speed, comprising:
a mode setting device for allowing a driver to set any one of a safety mode, a fuel economy mode, and a hybrid mode;
a safety speed input device allowing the driver to input a safety speed;
one or more processors configured to determine an economical speed on the basis of a driving environment of the vehicle; and
a controller communicatively connected to the one or more processors and configured to limit a speed of the vehicle on the basis of the safety speed or the economical speed according to a mode set by the driver.

2. The apparatus according to claim 1, wherein the one or more processors are further configured to determine, as a final economical speed, a minimum speed among an economical speed on the basis of a speed of a subject vehicle and a speed of a preceding vehicle, an economical speed on the basis of a fuel economy graph according to the speed of the subject vehicle, an economical speed on the basis of a speed profile according to a distance between the subject vehicle and a front obstacle, and a maximum speed of a driving road.

3. The apparatus according to claim 1, wherein the controller limits the speed of the vehicle on the basis of a torque corresponding to the input safety speed in the safety mode.

4. The apparatus according to claim 1, wherein the controller limits the speed of the vehicle on the basis of a torque corresponding to the determined economical speed in the fuel economy mode.

5. The apparatus according to claim 1, wherein the controller limits the speed of the vehicle on the basis of a torque corresponding to a lower speed of the input safety speed and the determined economical speed in the hybrid mode.

6. The apparatus according to claim 1, the one or more processors are further configured to calculate a required torque of the driver on the basis of a voltage value transmitted from an accelerator position sensor (APS).

7. The apparatus according to claim 6, wherein the controller limits the speed of the vehicle on the basis of a lower torque of a torque corresponding to the input safety speed and the required torque of the driver in the safety mode.

8. The apparatus according to claim 6, wherein the controller limits the speed of the vehicle on the basis of a lower torque of a torque corresponding to the determined economical speed and the required torque of the driver in the fuel economy mode.

9. The apparatus according to claim 6, wherein the controller limits the speed of the vehicle on the basis of a lower torque of a torque corresponding to the input safety speed, a torque corresponding to the determined economical speed, and the required torque of the driver in the hybrid mode.

10. A method for limiting a speed of a vehicle, comprising:
receiving, by a mode setting device, any one of a safety mode, a fuel economy mode, and a hybrid mode which is set by a driver;
receiving, by a safety speed input device, a safety speed which is input by the driver in the safety mode or the hybrid mode;
determining, by one or more processors, an economical speed on the basis of a driving environment of the vehicle in the fuel economy mode; and
limiting, by a controller, a speed of the vehicle on the basis of the safety speed or the economical speed according to a mode set by the driver.

11. The method according to claim 10, wherein the determining of the economical speed comprises:
calculating a first economical speed on the basis of a speed of a subject vehicle and a speed of a preceding vehicle;
calculating a second economical speed on the basis of a fuel economy graph according to the speed of the subject vehicle;
calculating a third economical speed on the basis of a speed profile according to a distance between the subject vehicle and a front obstacle;
acquiring a maximum speed of a driving road; and
determining, as a final economical speed, a minimum speed among the first to third economical speeds and the maximum speed.

12. The method according to claim 10, wherein the limiting of the speed comprises limiting the speed of the vehicle on the basis of a torque corresponding to the input safety speed in the safety mode.

13. The method according to claim 10, wherein the limiting of the speed comprises limiting the speed of the vehicle on the basis of a torque corresponding to the determined economical speed in the fuel economy mode.

14. The method according to claim 10, wherein the limiting of the speed comprises limiting the speed of the vehicle on the basis of a torque corresponding to a lower speed of the input safety speed and the determined economical speed in the hybrid mode.

15. The method according to claim 10, further comprising calculating a required torque of the driver on the basis of a voltage value transmitted from an accelerator position sensor (APS).

16. The method according to claim 15, wherein the limiting of the speed comprises limiting the speed of the vehicle on the basis of a lower torque of a torque corresponding to the input safety speed and the required torque of the driver in the safety mode.

17. The method according to claim 15, wherein the limiting of the speed comprises limiting the speed of the vehicle on the basis of a lower torque of a torque corresponding to the determined economical speed and the required torque of the driver in the fuel economy mode.

18. The method according to claim 15, wherein the limiting of the speed comprises limiting the speed of the vehicle on the basis of a lower torque of a torque corresponding to the input safety speed, a torque corresponding to the determined economical speed, and the required torque of the driver in the hybrid mode.

19. An apparatus of a vehicle for limiting vehicle speed, comprising:
an economical speed determination processor configured to determine an economical speed on the basis of a driving environment of the vehicle;
a torque calculation processor configured to calculate a required torque of a driver; and
a controller communicatively connected to the economical speed determination processor and the torque calculation processor, and configured to limit a speed of the vehicle on the basis of a lower torque of a torque corresponding to the determined economical speed and the required torque of the driver.

20. A method for limiting a speed of a vehicle, comprising:
determining, by an economical speed determination processor, an economical speed on the basis of a driving environment of the vehicle;
calculating, by a torque calculation processor, a required torque of a driver; and
limiting, by a controller, a speed of the vehicle on the basis of a lower torque of a torque corresponding to the determined economical speed and the required torque of the driver.
